(19) United States
(12) Patent Application Publication
(10) Pub. No.: US 2022/0193951 A1
(43) Pub. Date: Jun. 23, 2022

(54) Foldable tile saw

(71) Applicant: REXON INDUSTRIAL CORP., LTD., Taichung (TW)

(72) Inventor: WAN JIE YOU, Taichung (TW)

(73) Assignee: REXON INDUSTRIAL CORP., LTD., Taichung (TW)

(21) Appl. No.: 17/561,012

(22) Filed: Dec. 23, 2021

(30) Foreign Application Priority Data
Dec. 23, 2020 (TW) 109145785

(51) Int. Cl. B28D 1/04; B23D 47/02; B23D 59/02; B28D 7/02

(52) U.S. Cl. CPC B28D 1/044; B28D 7/02; B23D 59/02; B23D 47/025

(57) ABSTRACT

A foldable tile saw suitable includes a base unit including a seat body and a water tank, a connecting unit including a connecting arm having a first section and a second section, and a saw unit including a saw blade seat and a saw blade. The connecting arm can rotate between an approaching position and a distant position relative to the water tank around a first axial line to generate positioning. The saw blade seat has a connecting portion and a cutting portion. The saw blade seat can rotate between a cutting position and a folded position around a second axial line relative to the water tank and generate positioning. As long as the connecting arm is rotated to the approaching position, and the saw blade seat is rotated to the folded position, the cutting portion can be approached to the water tank, so the storage space can be effectively reduced.

### BACKGROUND OF THE INVENTION

### 1. Field of the Invention

The present invention relates to a cutting machine, in particular to a foldable tile saw that can reduce folding volume.

### 2. Description of the Related Art

Due to the high hardness and material characteristics of the ceramic tiles, it is necessary to use a tile saw for cutting during processing.

An existing tile saw comprises a base, a sink recessed on the base, a working plate slidably provided on the base and for placing a tile on the base, and a saw blade fixed on the base. When using the existing tile saw, a user needs to place the tile on the work plate and push the work plate to make the tile contact the saw blade and be cut.

The saw blade of the existing tile saw is fixed on the base, the existing tile saw cannot be folded. Generally, when cutting tiles, water needs to be poured while cutting (not shown) to help lubricate and remove cutting dust and prevent overheating. Therefore, the sink needs to be set up to contain the water and dust. The depth of the sink can easily reach 20 or 30 cm, so it will occupy a lot of space when not in use. Not only is it not easy to carry and transport, but the exposed saw blade is also prone to damage due to collisions, so there is a need for improvement.

### SUMMARY OF THE INVENTION

The present invention has been accomplished under the circumstances in view. It is the main object of the present to provide a tile saw that is foldable.

The foldable tile saw unit comprises a base unit, a connecting unit, and a saw unit. The base unit comprises a seat body, and a water tank installed in the seat body. The water tank comprises an opening. Define the opening direction of the opening as a first axis, and the long direction and short direction of the opening as a second axis and a third axis respectively. The connecting unit comprises a connecting arm. The connecting arm comprises a first section rotatably connected to the base unit, and a second section opposite to the first section. The connecting arm can be rotate between an approaching position and a distant position relative to the water tank around a first axial line extending along the third axis to generate positioning. The second section is relatively close to the water tank when at the approaching position. The second section is relatively far away from the water tank and located above the water tank when at the distant position. The saw unit is set above the water tank, and comprises a saw blade seat and a saw blade pivoted on the saw blade seat. The saw blade seat comprises a connecting portion rotatably connected to the second section, and a cutting portion connected to the connecting portion for pivoting of the saw blade. The saw blade seat can be rotated relative to the water tank around a second axial line extending along the third axis between a cutting position where the cutting portion is relatively far away from the water tank and a folded position where the cutting portion is relatively close to the water tank.

The effect of the present invention is: The connecting arm is rotatably connected to the seat body, and the saw blade seat is rotatably connected to the second section. As long as the connecting arm is rotated to the approaching position, and the saw blade seat is rotated to the folded position, the cutting portion can be approached to the water tank, so the storage space can be effectively reduced.

Other advantages and features of the present invention will be fully understood by reference to the following specification in conjunction with the accompanying drawings.

### BRIEF DESCRIPTION OF THE DRAWINGS

FIG. 1 is an elevational assembly diagram of an embodiment of the foldable tile saw of the present invention.

FIG. 2 is an exploded view of the embodiment.

FIG. 3 is an incomplete exploded view of a base unit, a connecting unit, a saw unit, and a worktable unit of the embodiment viewed from another angle.

FIG. 4 is a plan top view of the embodiment.

FIG. 5 is an incomplete cross-sectional view taken along the line V-V of FIG. 4.

FIG. 6 is a schematic right side view illustrating that a connecting arm of this embodiment is at a distant position relative to a water tank, and a saw blade seat is at a cutting position relative to the water tank.

FIG. 7 is a diagram similar to FIG. 6, illustrating that the connecting arm of the embodiment is in an approaching position relative to the water tank, and the saw blade seat is in the cutting position relative to the water tank.

FIG. 8 is an incomplete cross-sectional view taken along the line VIII-VIII of FIG. 4.

FIG. 9 is another right side view, illustrating that the connecting arm of the embodiment is in the approaching position relative to the water tank, and the saw blade seat is in a folded position relative to the water tank, and the water tank is relative to a seat body in an enlarged state.

FIG. 10 is a diagram similar to FIG. 9, illustrating that the water tank is in a reduced state relative to the seat body.

### DETAILED DESCRIPTION OF THE INVENTION

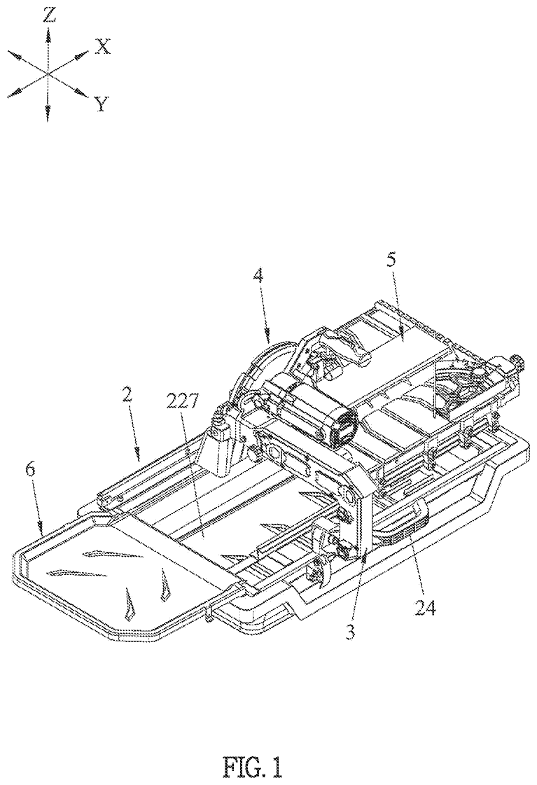

Referring to FIGS. 1-3, an embodiment of the foldable tile saw of the present invention is suitable for being detachably installed in a supporting unit (not shown) and suitable for cutting a tile (not shown).

The foldable tile saw comprises a base unit 2, a connecting unit 3, a saw unit 4, a workbench unit 5, and a baffle unit 6.

The base unit 2 comprises a frame-shaped seat body 21 detachably connected to the supporting unit, a water tank 22 provided on the seat body 21, a positioning block 23 provided on the seat body 21, and a handle 24. In this embodiment, the seat body 21 has four grooves (not shown), and the grooves can be inserted by the supporting unit to support the foldable tile saw.

The water tank 22 comprises a tank bottom 221, a surrounding portion 222 extending upward from the periphery of the tank bottom 221 and connected to the seat body 21, a hard portion 223 connecting the surrounding portion 222 and the seat body 21, and an accommodating space 224 defined by the tank bottom 221 and the surrounding portion 222, the accommodating space being changeable in volume. The surrounding portion 222 has a plurality of folding regions 225 concentrically surrounding the tank bottom 221 and connected to each other. A crease 226 is formed between every two adjacent folding regions 225.

The accommodating space 224 has an opening 227. The opening direction of the opening 227 is defined as a first axis Z, and the long direction and the short direction of the opening 227 are defined as a second axis X and a third axis Y, respectively. In this embodiment, the first axis Z, the second axis X, and the third axis Y are perpendicular to each other. The seat body 21 surrounds a connecting axis L extending along the first axis Z and passing through the tank bottom 221.

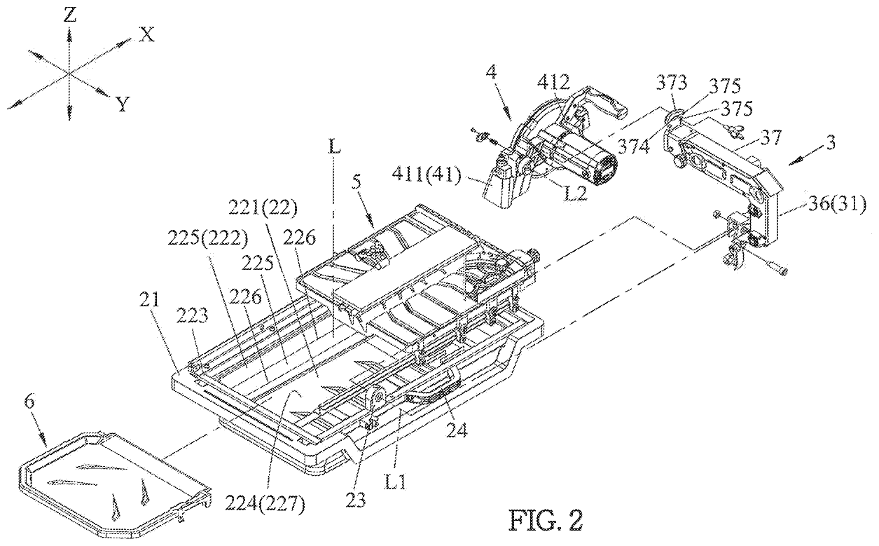

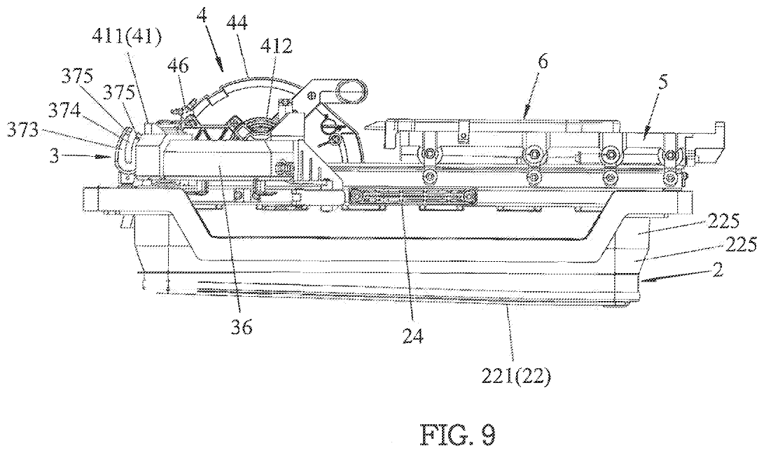

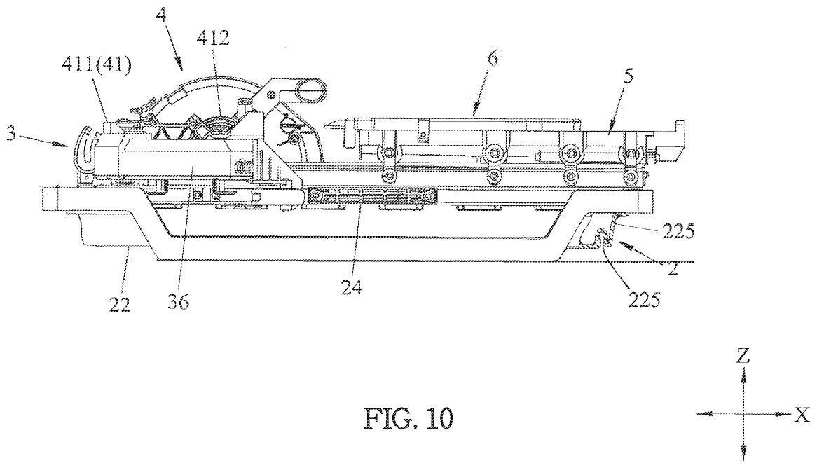

Referring to FIGS. 2, 9 and 10, the water tank 22 can be operated to move between an enlarged state and a reduced state relative to the seat body 21. In the enlarged state (see FIG. 9), the folding regions 225 are continuously extended, the tank bottom 221 is relatively far away from the seat body 21, and the accommodating space 224 has the largest volume. In the reduced state (see FIG. 10), the folding regions 225 are sequentially reversely bent and folded, the tank bottom 221 is relatively close to the seat body 21, and the accommodating space 224 has the smallest volume. In this embodiment, the surrounding portion 222 of the water tank 22 is made of rubber material, so the water tank 22 can be moved between the enlarged state and the reduced state by means of pressing. When the water tank 22 is in the reduced state, the folding regions 225 are sequentially bent upwards and downwards, so that the folding regions 225 overlap each other along the second axis X.

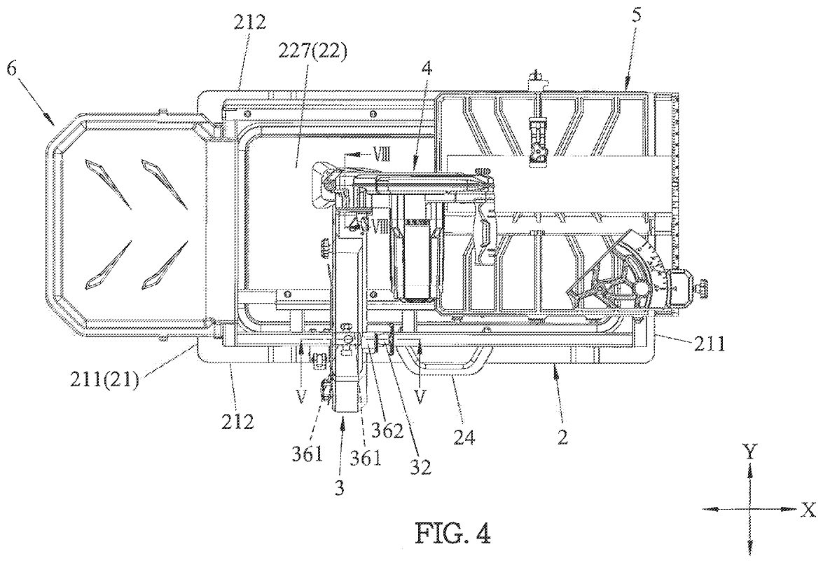

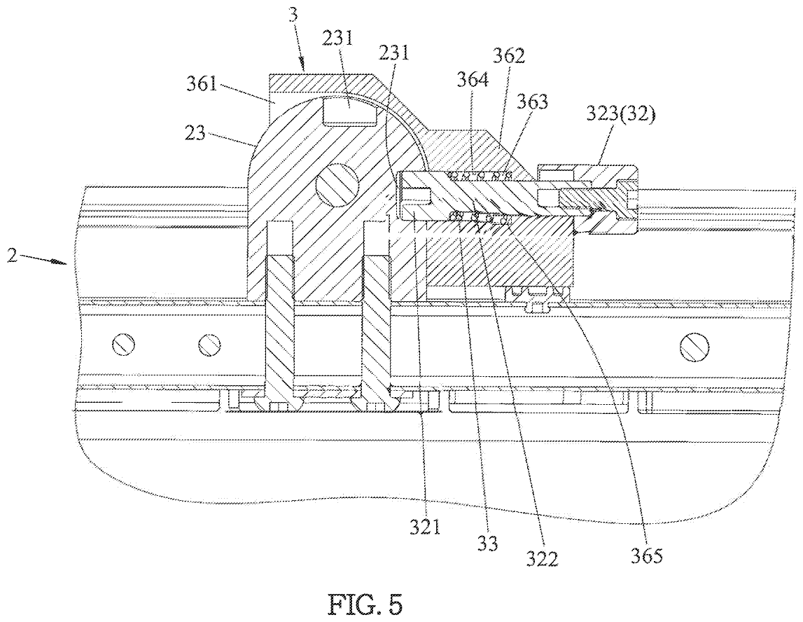

Referring to FIGS. 2-5, the seat body 21 has two first side surfaces 211 oppositely arranged along the second axis X, and two second side surfaces 212 connected to the first side surfaces 211 and arranged oppositely along the third axis Y. The handle 24 is set on one of the second side surfaces 212.

A first axial line L1 passing through the positioning block 23 and extending along the third axis Y is defined. The positioning block 23 has two positioning grooves 231 spaced around the first axial line L1.

The connecting unit 3 comprises a connecting arm 31 connected to the seat body 21, a positioning pin 32 that can be alternatively inserted into the positioning grooves 231, a first elastic member 33 arranged around the positioning pin 32, an engaging pin 34 that can be inserted into the connecting arm 31 opposite to the end of the seat body 21, and a second elastic member 35 that is arranged around the engaging pin 34.

The connecting arm 31 has a first section 36 rotatably connected to the base unit 2, and a second section 37 opposite to the first section 36 and for connecting the saw unit 4. In this embodiment, the second section 37 is perpendicular to the first section 36.

The first section 36 has two first side walls 361 arranged on opposite sides of the positioning block 23 at intervals along the first axial line L1, a second side wall 362 connected between the first side walls 361, and a perforation 363 that passes through the second side wall 362 and allows the positioning pin 32 to pass through and is in the shape of a step hole. The second side wall 362 has an annular hole surface 364 surrounding the perforation 363. The annular hole surface 364 has a detent area 365 facing the positioning block 23. In this embodiment, the second section 37 is perpendicular to the first section 36.

The second section 37 has an abutting surface 371 opposite to the first section 36 and connected to the saw unit 4, two engaging grooves 372 recessed on the abutting surface 371 and spaced around a second axial line L2 extending along the third axis Y, and capable of allowing the engaging pin 34 to be inserted alternatively, an extension wall 373 extending away from the second axial line L2, a guide groove 374 passing through the extension wall 373 and curved around the second axial line L2 and having one end open, and two protrusions 375 adjacent to the open end of the guide groove 374 (see FIG. 9).

The positioning pin 32 has an insertion section 321 that can be alternatively inserted into the positioning grooves 231, a neck section 322 connected to the insertion section 321 and having an outer contour smaller than the insertion section 321, and a pulling section 323 exposed outside the second side wall 362 and having a contour larger than the perforation 363 and pressing against the second side wall 362. The first elastic member 33 is arranged around the neck section 322 and the two ends are respectively pressed against the insertion section 321 and the detent area 365.

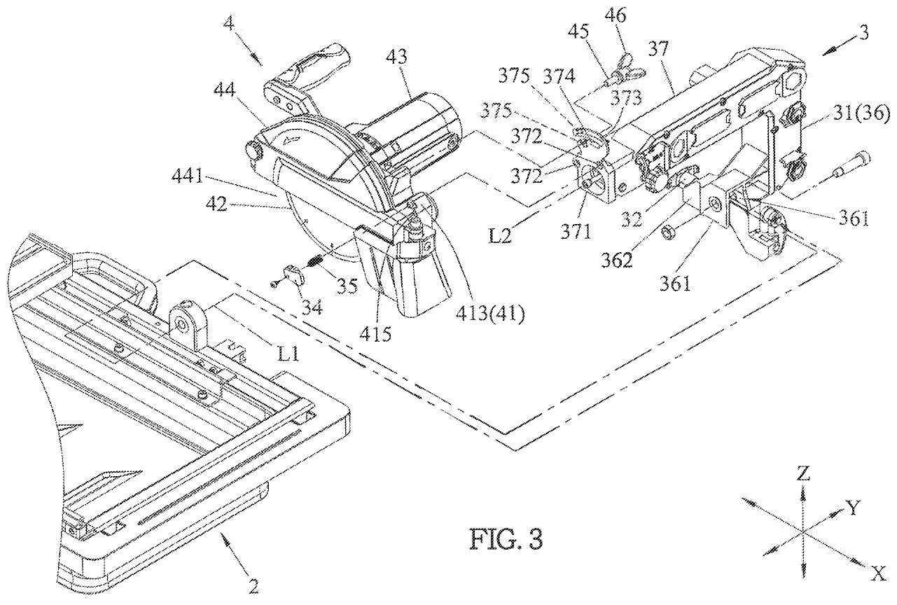

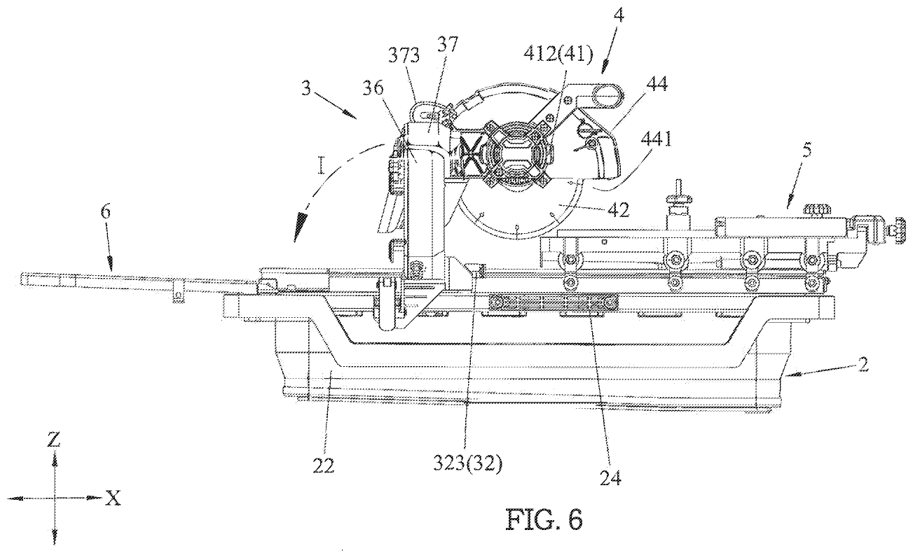

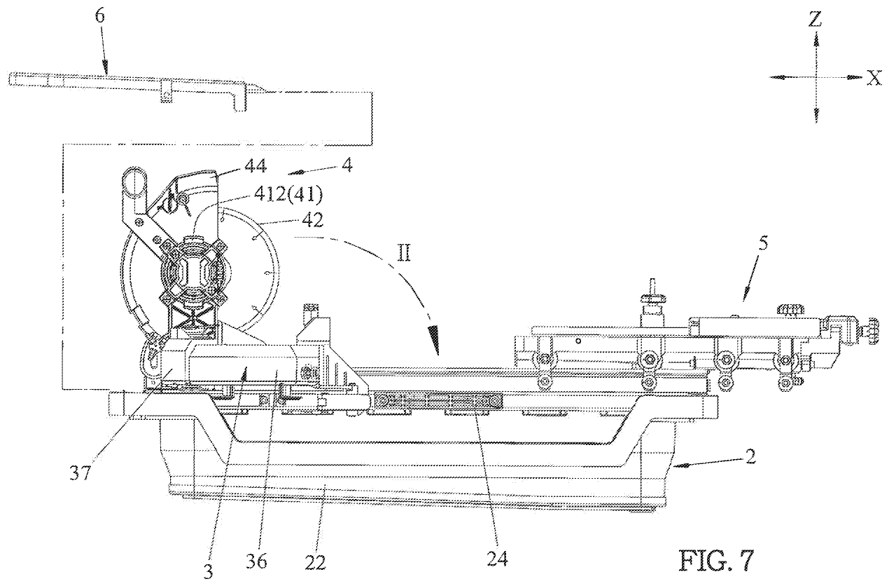

Referring to FIGS. 3 and 5 to 7, the connecting arm 31 can rotate around the first axial line L1 relative to the water tank 22 at a distant position and an approaching position to generate positioning. In the distant position (see FIG. 6), the second section 37 is relatively far away from the water tank 22 and above the water tank 22, and the extension direction of the first section 36 is substantially parallel to the first axis Z. In the approaching position (see FIG. 7), the second section 37 is relatively close to the water tank 22, and the extension direction of the first section 36 is substantially parallel to the second axis X.

The positioning pin 32 penetrates the perforation 363, and can be operated to be inserted into the positioning grooves 231 alternatively so that the connecting arm 31 is positioned relative to the water tank 22 at the approaching position or the distant position. The first elastic member 33 is disposed on the perforation 363 and can constantly provide a potential energy to keep the positioning pin 32 inserted in the corresponding positioning groove 231.

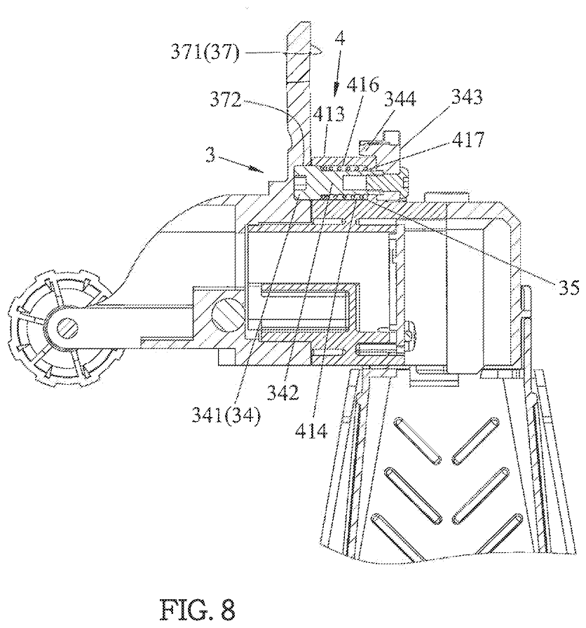

Referring to FIGS. 2, 3, 6 and 8, the saw unit 4 is connected to the connecting arm 31 and disposed above the water tank 22, and comprises a saw blade seat 41 pivotally connected to the abutting surface 371 along the second axial line L2, a saw blade 42 pivoted on the saw blade seat 41, and a drive motor 43 provided on the saw blade seat 41 and capable of driving the saw blade 42 to rotate, a protective cover 44 provided on the saw blade seat 41 and partially surrounding the outside of the saw blade 42, a guide rod 45 connected to the saw blade seat 41 and slidably provided on the guide groove 374 around the second axial line L2, and an operating bolt 46 screwed to the guide rod 45 and operable to be tightened on the protrusions 375. The protective cover 44 has a gap 441 for part of the saw blade 42 to be exposed. The protrusions 375 of the connecting unit 3 are arranged on the side of the extension wall 373 opposite to the saw blade seat 41.

The saw blade seat 41 has a connecting portion 411 rotatably connected to the abutting surface 371, and a cutting portion 412 connected to the connecting portion 411 and for the saw blade 42 to pivot.

The connecting portion 411 has a connecting wall 413 adjacent to the abutting surface 371, a jack 414 passing through the connecting wall 413 and shaped like a step hole for the engaging pin 34 to insert, and a clamping block 415 protruding from the side of the connecting wall 413 opposite to the abutting surface 371. The connecting wall 413 has a surrounding surface 416 defining the jack 414. The surrounding surface 416 has an abutting area 417 facing the second section 37.

The engaging pin 34 has a stop section 341 that can be inserted into the engaging grooves 372 alternatively, a small diameter section 342 connected to the stop section 341 and having an outer contour smaller than the stop section 341, an operating section 343 exposed outside the connecting wall 413 and larger in outline than the jack 414, and an engaging block 344 protrudingly provided on one side of the operating section 343 adjacent to the connecting wall 413. The second elastic member 35 is wound around the small diameter section 342, and the two ends are respectively against the stop section 341 and the abutting area 417.

Referring to FIGS. 6-9, the saw blade seat 41 can rotate around the second axial line L2 with respect to the water tank 22 between a cutting position and a folded position to generate positioning. At the cutting position (see FIG. 6 and FIG. 7), the cutting portion 412 is relatively far away from the water tank 22. At the folded position, the cutting portion 412 is relatively close to the water tank 22 (see FIG. 9).

The engaging pin 34 passes through the jack 414, and can be operated to be selectively inserted into one of the engaging grooves 372 (see FIG. 3) to make the saw blade seat 41 be positioned relative to the water tank 22 at the cutting position or the folded position. The second elastic member 35 is arranged on the jack 414 and can constantly provide a potential energy to keep the engaging pin 34 inserted in the corresponding engaging groove 372.

The worktable unit 5 is slidably arranged on the base unit 2 and is suitable for driving the tile to approach or move away from the saw unit 4. The baffle unit 6 can be detached and installed alternatively on the seat body 21 and the workbench unit 5. When the baffle unit 6 is installed on the seat body 21, it corresponds to one of the second side surfaces 212, so as to block the water splash when cutting the tile.

Referring to FIGS. 3, 5, 6 and 8, when a user wants to use the foldable tile saw, the user needs to install the base unit 2 on the supporting unit, then pull the pulling section 323 of the positioning pin 32 to move the insertion section 321 away from the positioning grooves 231 and press the first elastic member 33 and operate synchronously to rotate the connecting arm 31 to the distant position. Then the pulling section 323 is released, and the insertion section 321 will be supported by the first elastic member 33 and inserted into the corresponding positioning groove 231 so that the connecting arm 31 is positioned relative to the water tank 22. Then the user pulls the operating section 343 of the engaging pin 34 to keep the stop section 341 away from the engaging grooves 372 and press the second elastic member 35, and operates synchronously to rotate the saw blade seat 41 to the cutting position. Then release the operating section 343, and the stop section 341 will be supported by the second elastic member 35 and inserted into the corresponding engaging groove 372 to position the saw blade seat 41 relative to the water tank 22. Then the operating bolt 46 is operated so that the operating bolt 46 presses the protrusions 375 (see FIG. 2) and confines the guide rod 45 to the guide groove 374. In addition, installing the baffle unit 6 on the seat body 21 and operating the water tank 22 to move to the enlarged state can operate the foldable tile saw into the state shown in FIG. 6. Finally, place the tile on the worktable unit 5 to start cutting the tile.

Referring to FIGS. 3, 5, 8 and 9, when the user wants to store the foldable tile saw, it is also similar to the above steps. First pull the pulling section 323 of the positioning pin 32 to move the insertion section 321 away from the positioning grooves 231 and press the first elastic member 33, and operate synchronously to rotate the connecting arm 31 to the approaching position (as shown in FIG. 7). Then the pulling section 323 is released so that the insertion section 321 is inserted into another positioning groove 231, so that the connecting arm 31 is positioned relative to the water tank 22.

Then release the operating bolt 46 to keep the operating bolt 46 away from the protrusions 375 (see FIG. 2), and pull the operating section 343 of the engaging pin 34 to move the stop section 341 away from the engaging grooves 372 and press the second elastic member 35, and operate synchronously to rotate the saw blade seat 41 to the folded position, and then release the operating section 343, so that the stop section 341 is inserted into another engaging groove 372, so that the saw blade seat 41 is positioned relative to the water tank 22. In addition, install the baffle unit 6 on the worktable unit 5 and remove the supporting unit to reach the state shown in FIG. 9.

Referring to FIGS. 2, 3 and 10, finally, the water tank 22 is operated to the reduced state, which can effectively reduce the height and length of the foldable tile saw and is easy to store.

In this way, the connecting arm 31 is rotatably connected to the seat body 21, and the saw blade seat 41 is rotatably connected to the second section 37. As long as the connecting arm 31 is rotated to the approaching position, and the saw blade seat 41 is rotated to the folded position, the cutting portion 412 can be approached to the water tank 22, so the storage space can be effectively reduced.

In addition, when it needs to be transported, the user can conveniently hold the handle 24 to transport the foldable tile saw. Since the handle 24 is set on the first side surface 211, when the handle 24 is held, the first axial line L1 and the second axial line L2 (that is, the rotation axis of the connecting arm 31 and the saw blade seat 41) extend substantially vertically, therefore, it is less likely to be affected by gravity and cause the connecting arm 31 to rotate toward the distant position, or cause the saw blade seat 41 to rotate toward the cutting position.

It should be noted that in the process of cutting tiles, it is usually necessary to pour water while cutting (not shown) to help lubricate and prevent overheating. The water tank 22 can contain the water and avoid spillage. Moreover, since the material hardness of the hard portion 223 is greater than that of the surrounding portion 222 and is connected between the surrounding portion 222 and the seat body 21, it is less deformed and can avoid that the water tank 22 is separated from the seat body 21 due to the increase in the amount of water in the accommodating space 224.

Referring to FIGS. 2, 3 and 8, it should be particularly noted that the engaging pin 34 has the engaging block 344 protruding from the operating section 343 adjacent to the connecting wall 413, and the connecting portion 411 has the clamping block 415 protruding from the connecting wall 413 opposite to the abutting surface 371. When the stop section 341 is inserted into one of the engaging grooves 372, the engaging block 344 and the clamping block 415 are misaligned, that is to say, the operating section 343 is attached to the connecting wall 413. But in the above steps, after the user pulls the operating section 343, he can also rotate the operating section 343 so that the engaging block 344 corresponds to the clamping block 415 to keep the operating section 343 and the connecting wall 413 at a distance, and to keep the stop section 341 away from the engaging grooves 372. In this way, the user does not need to keep holding the operating section 343 and can turn the saw blade seat 41 with both hands.

It is worth mentioning that because the saw blade seat 41 is equipped with the drive motor 43, the weight is heavier and the torque is larger. By setting the extension wall 373, the guide groove 374, the protrusions 375, and the operating bolt 46, the moment that the saw blade seat 41 bears when the engaging pin 34 is in the cutting position can be dispersed, and when cutting the tile, it can also reduce vibration and shaking and improve the cutting quality.

It should be noted that in this embodiment, when the water tank 22 is in the reduced state, the folding regions 225 are repeatedly bent upward and downward in sequence, so that the folding regions 225 are superimposed on each other along the second axis X, so that the height of the water tank 22 can be reduced by more than half. Moreover, compared with other folding regions 225 that are repeatedly bent inward and outward in order, that is, the implementation mode (not shown) in which the folding regions 225 are stacked on top of each other along the first axis Z (not shown), the height reduced by this embodiment is larger. The overlapping manner of the folding regions 225 in this embodiment is less affected by gravity to cause the water tank 22 to be restored to the enlarged state.

In addition, in this embodiment, the surrounding portion 222 of the water tank 22 is made of rubber material, so the water tank 22 can be moved between the enlarged state and the reduced state by pressing. But not limited to this, the surrounding portion 222 can also be made of other soft materials, and can also move the water tank 22 from the reduced state to the enlarged state through the weight of the water carried (not shown), and there is no need to operate in a way of pressure.

Referring to FIGS. 2, 3, 6 and 7, it should be noted that the rotation direction of the connecting arm 31 from the distant position to the approaching position is defined as a first direction I, and the rotation direction of the saw blade seat 41 from the cutting position to the folded position is defined as a second direction II. In this embodiment, the second direction II is opposite to the first direction I. In this way, the volume can be minimized and the saw blade 42 can be kept facing down when storing. In addition, by setting the protective cover 44, when the connecting arm 31 is in the approaching position and the saw blade seat 41 is in the folded position, the gap 441 faces the water tank 22, therefore, the saw blade 42 can be prevented from being exposed and damaged during storage or transportation.

In summary, in the foldable tile saw of the present invention, because the connecting arm 31 is rotatably connected to the seat body 21 and the saw blade seat 41 is rotatably connected to the second section 37, as long as the connecting arm 31 is rotated to the approaching position and the saw blade seat 41 is rotated to the folded position, the cutting portion 412 can approach the water tank 22, the storage space can be effectively reduced, so it can indeed achieve the purpose of the invention.

However, the above are only examples of the present invention, and should not be used to limit the scope of implementation of the present invention. All simple equivalent changes and modifications made according to the scope of the patent application of the present invention and the content of the patent specification are still within the scope of the patent of the present invention.

What is claimed is:

1. A foldable tile saw, suitable for detachable installation in a supporting unit, comprising:
a base unit comprising a seat body and a water tank installed in said seat body, said water tank comprising an opening, the opening defining an opening direction of said opening as a first axis, a long direction of said opening defining a second axis and a short direction of said opening defining a third axis;
a connecting unit comprising a connecting arm, said connecting arm comprising a first section rotatably connected to said base unit and a second section opposite to said first section, said connecting arm being rotatable between an approaching position and a distant position relative to said water tank around a first axial line extending along said third axis to generate positioning, said second section being relatively close to said water tank when at said approaching position, said second section being relatively far away from said water tank and located above said water tank when at said distant position; and
a saw unit set above said water tank, said saw unit comprising a saw blade seat and a saw blade pivoted on said saw blade seat, said saw blade seat comprising a connecting portion rotatably connected to said second section, and a cutting portion connected to said connecting portion for pivoting of said saw blade, said saw blade seat being rotatable relative to said water tank around a second axial line extending along said third axis between a cutting position where said cutting portion is relatively far away from said water tank and a folded position where said cutting portion is relatively close to said water tank.

2. The foldable tile saw as claimed in claim 1, wherein the rotation direction of said connecting arm from said distant position to said approaching position is defined as a first direction, the rotation direction of said saw blade seat from said cutting position to said folded position is defined as a second direction, and said second direction is opposite to said first direction.

3. The foldable tile saw as claimed in claim 2, wherein said first axis, said second axis and said third axis are perpendicular to each other; when said connecting arm is in said distant position, the extension direction of said first section is substantially parallel to said first axis; when said connecting arm is in said approaching position, the extension direction of said first section is substantially parallel to said second axis.

4. The foldable tile saw as claimed in claim 3, wherein said saw unit further comprises a protective cover provided on the saw blade seat and partially surrounding the outside of said saw blade, said protective cover comprising a gap for part of said saw blade to be exposed, said gap facing said water tank when said connecting arm is in said approaching position and said saw blade seat is in said folded position.

5. The foldable tile saw as claimed in claim 2, wherein said base unit further comprises a positioning block arranged on said seat body for said first axial line to pass through, said positioning block comprising two positioning grooves spaced around said first axial line; said first section of said connecting unit comprises two first side walls arranged on opposite sides of said positioning block at intervals along said first axial line, a second side wall connected between said first side walls, and a perforation that passes through said second side wall; said connecting unit further comprises a positioning pin, said positioning pin passing through said perforation, and operable to be inserted into said positioning grooves alternatively so that said connecting arm is positioned relative to said water tank at said approaching position or said distant position.

6. The foldable tile saw as claimed in claim 5, wherein said connecting unit further comprises a first elastic member, said first elastic member being set on said perforation to constantly provide a potential energy to keep said positioning pin inserted in the corresponding said positioning groove.

7. The foldable tile saw as claimed in claim 2, wherein said second section of said connecting unit comprises an abutting surface to which said saw blade seat is connected, and two engaging grooves arranged on said abutting surface and spaced around said second axial line; said connecting portion of said saw unit comprises a connecting wall adjacent to said abutting surface, and a jack passing through said connecting wall; said connecting unit further comprises an engaging pin, said engaging pin penetrating said jack and operable to be inserted into said engaging grooves selectively to position said saw blade seat relative to said water tank in said cutting position or said folded position.

8. The foldable tile saw as claimed in claim 7, wherein said connecting unit further comprises a second elastic member, said e second elastic member being set on said jack to constantly provide a potential energy to keep said engaging pin inserted in the corresponding said engaging groove.

9. The foldable tile saw as claimed in claim 7, wherein said second section of said connecting unit further comprises an extension wall extending away from said second axial line, a guide groove passing through said extension wall and curved around said second axial line, and a protrusion arranged on the side of said extension wall opposite to said saw blade seat and adjacent to said guide groove; said saw unit further comprises a guide rod connected to said saw blade seat and slidably arranged on said guide groove around said second axial line, and an operating bolt screwed to said guide rod and operable to be pressed against said protrusion.

10. The foldable tile saw as claimed in claim 3, wherein said seat body of said base unit comprises two first side surfaces oppositely arranged along said second axis, and two second side surfaces connected to said first side surfaces and arranged oppositely along said third axis; said base unit further comprises a handle set on one said second side surface.
